(19) United States
(12) Patent Application Publication
(10) Pub. No.: US 2008/0040342 A1
(43) Pub. Date: Feb. 14, 2008

(54) Data processing apparatus and methods

(76) Inventors: Robert M. Hust, Hayden, ID (US); James Straub III, Coeur d'Alene, ID (US)

Correspondence Address: WELLS ST. JOHN P.S., 601 W. FIRST AVENUE, SUITE 1300, SPOKANE, WA, 99201, US

(21) Appl. No.: 11/895,263

(22) Filed: Aug. 23, 2007

Related U.S. Application Data
(63) Continuation-in-part of application No. 11/216,704, filed on Aug. 30, 2005.
(60) Provisional application No. 60/607,549, filed on Sep. 7, 2004.

(51) Int. Cl. G06F 17/30; G06F 7/02

(52) U.S. Cl. 707/5; 707/102; 707/E17.017; 707/E17.005

(57) ABSTRACT

Data processing apparatus and methods are described. According to one embodiment, a data processing method includes identifying a plurality of tokens for a plurality of data items, first selecting some of the tokens of the data items as being indicative of content of respective ones of the data items, after the first selecting, combining the first selected tokens with other content of the data items to form combined tokens, and after the combining, second selecting some of the tokens including at least one of the combined tokens as being indicative of content of the data items.

### CROSS REFERENCE TO RELATED APPLICATION

This application is a continuation-in-part of U.S. patent application Ser. No. 11/216,704, entitled Heterogeneous Mapped Address Indexing System with Dynamic Signal Definition, naming Robert Michael Hust and James Joseph Straub, III as inventors, and which was filed on Aug. 30, 2005, and claims the benefit of a U.S. Provisional Application Ser. No. 60/607,549, Heterogeneous Mapped Address Indexing System with Dynamic Signal Definition, naming Robert Michael Hust and James Joseph Straub, III as inventors, and which was filed on Sep. 7, 2004, and teachings of both of which are incorporated by reference herein.

### TECHNICAL FIELD

Aspects of the disclosure relate to data processing apparatus and methods.

### BACKGROUND OF THE DISCLOSURE

Information systems may be comprised of a morass of documents that is unstructured. For example, the Internet is a prime example of a morass of documents of unstructured heterogeneous data. Search engines on the internet may develop their own taxonomies for each web page based on human interpretation and known taxonomies. This situation may also apply to networks within organizations, email servers and legacy information archives, etc. Organization of the information and fast retrieval of the information generally requires human effort to look at each document and place each document into an appropriate taxonomy or to assign meta-data to the document. Both exercises may utilize a relatively significant amount of human labor proportional to the size of the document space.

Some embodiments of the disclosure are directed to information indexing and taxonomic systems and methods. Methods and apparatus for organizing, classifying, searching and/or processing a plurality of data items are described according to some embodiments.

### BRIEF DESCRIPTION OF THE DRAWINGS

Embodiments of the disclosure are described below with reference to the following accompanying drawings.

FIG. 1 is functional block diagram of a data processing apparatus according to one embodiment.

FIG. 2 is a flow chart of a method of generating taxonomies and classifying a plurality of data items according to one embodiment.

FIG. 3 is an example of an image including a cumulus cloud.

FIG. 4 is an example of an image including a stratus cloud.

FIG. 5 is a flow chart of a method of classifying a plurality of data items according to one embodiment.

FIG. 6 is a flow chart of a method of classifying a plurality of data items according to one embodiment.

FIG. 7 is a flow chart of a searching method according to one embodiment.

FIG. 8 is an illustrative representation of a heterogeneous mapped address indexing system with dynamic signal definition according to one embodiment.

### DETAILED DESCRIPTION OF THE PREFERRED EMBODIMENTS

This disclosure is submitted in furtherance of the constitutional purposes of the U.S. Patent Laws “to promote the progress of science and useful arts” (Article 1, Section 8).

As discussed below, data processing methods and apparatus are disclosed according to some embodiments of the disclosure. In one embodiment, methods and apparatus provide a computer indexing and taxonomic system which may determine taxonomies and/or classify data items. According to some embodiments of the disclosure, the methods and apparatus may process data items to determine taxonomies, for classification or the taxonomies may be provided differently, for example, entered by a user. The taxonomies are classification categories which are usable to classify data items and which are indicative of content of the data items in one embodiment. Methods and apparatus of the disclosure may implement searching operations to return data items which may be relevant to a search query according to some embodiments. At least some embodiments are substantially automatic wherein generating taxonomies, classifying data items, and/or searching data items may be performed with reduced, minimal or no action by a user.

According to one embodiment described in further detail below, apparatus and methods for indexing and combining tokens are described. For example, tokens of an input data stream may be indexed, combined and provided into an addressable memory space in a manner which optimizes and accelerates data item look-up, introspection, re-definition, and/or recursive indexing, and/or provides an automatic inference for constructing taxonomies around the inputted data. In one embodiment, tokens may be written into blocks of addressable memory in a manner where individual blocks are singularly representative of occurrences of a distinct token irrespective of data type (e.g., text, images, video, molecules, etc.). In one embodiment, tokens may be valued across the entire data set and higher valued tokens may be used to provide elements for combined tokens which may be recursively valued as tokens. Taxonomies may be automatically inferred from higher value tokens and combined tokens irrespective of data types in one embodiment.

In one embodiment, a new and useful taxonomy inference engine is disclosed which is simpler in construction, more universally usable, and more versatile in operation than other arrangements. Methods and apparatus of one embodiment may tokenize heterogeneous data input streams (e.g., text, images, and video) into atomic tokens. The tokens may be valued and relatively highly valued tokens may be analyzed and used to construct combined tokens in one embodiment. The combined tokens may be recursively analyzed and valued in the same manner as the original tokens present in the original data in one embodiment. High value tokens which may include original or combined tokens may be used to generate taxonomic categories. This process may be repeated for each data item in a data set or information space in one embodiment. Additional embodiments are disclosed as is apparent from the following discussion.

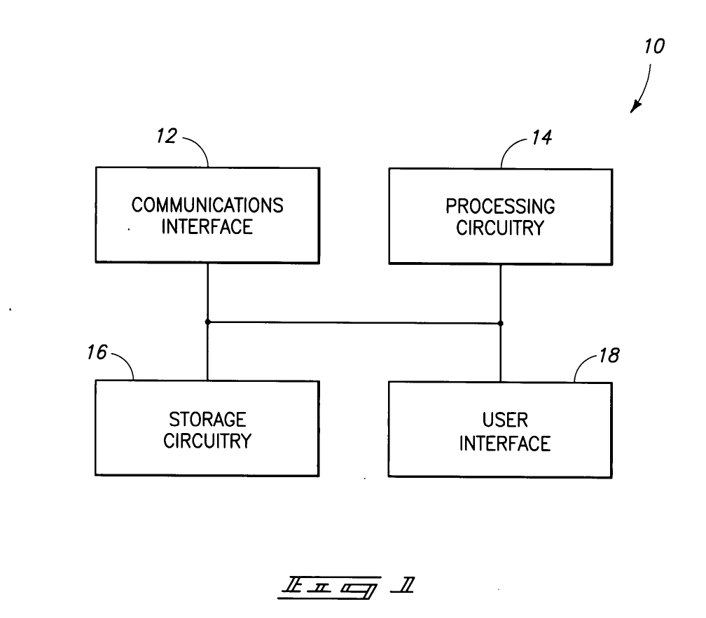

Referring to FIG. 1, an example configuration of a data processing apparatus 10 is shown according to one embodiment. In one embodiment, the data processing apparatus 10 may be implemented using a personal computer, work station, multiprocessor system, portable computer, mainframe computer, networked computer, or other processing device. The depicted embodiment of data processing apparatus 10 includes a communications interface 12, processing circuitry 14, storage circuitry 16, and a user interface 18. Other configurations of data processing apparatus 10 are possible including more, less and/or additional components.

Communications interface 12 is arranged to implement communications of data processing apparatus 10 with respect to external devices (not shown). For example, communications interface 12 may be arranged to communicate information bi-directionally with respect to data processing apparatus 10. Communications interface 12 may be implemented as a network interface card (NIC), serial or parallel connection, USB port, Firewire interface, flash memory interface, floppy disk drive, or any other suitable arrangement for communicating with respect to data processing apparatus 10.

In one embodiment, processing circuitry 14 is arranged to process data, control data access and storage, issue commands, and control other desired operations. Processing circuitry 14 may comprise circuitry configured to implement desired programming provided by appropriate media in at least one embodiment. For example, the processing circuitry 14 may be implemented as one or more of a processor and/or other structure configured to execute executable instructions including, for example, software and/or firmware instructions, and/or hardware circuitry. Exemplary embodiments of processing circuitry 14 include hardware logic, PGA, FPGA, ASIC, state machines, and/or other structures alone or in combination with a processor. These examples of processing circuitry 14 are for illustration and other configurations are possible.

The storage circuitry 16 is configured to store programming such as executable code or instructions (e.g., software and/or firmware), electronic data, databases, or other digital information and may include processor-usable media. Processor-usable media may be embodied in any computer program product(s) or article of manufacture(s) which can contain, store, or maintain programming, data and/or digital information for use by or in connection with an instruction execution system including processing circuitry in the exemplary embodiment. For example, exemplary processor-usable media may include any one of physical media such as electronic, magnetic, optical, electromagnetic, infrared or semiconductor media. Some more specific examples of processor-usable media include, but are not limited to, a portable magnetic computer diskette, such as a floppy diskette, zip disk, hard drive, random access memory, read only memory, flash memory, cache memory, and/or other configurations capable of storing programming, data, or other digital information.

At least some embodiments or aspects described herein may be implemented using programming stored within appropriate storage circuitry described above and/or communicated via a network or other transmission media and configured to control appropriate processing circuitry. For example, programming may be provided via appropriate media including, for example, embodied within articles of manufacture. In another example, programming may be embodied within a data signal (e.g., modulated carrier wave, data packets, digital representations, etc.) communicated via an appropriate transmission medium, such as a communication network (e.g., the Internet and/or a private network), wired electrical connection, optical connection and/or electromagnetic energy, for example, via a communications interface, or provided using other appropriate communication structure. Exemplary programming including processor-usable code may be communicated as a data signal embodied in a carrier wave in but one example.

User interface 18 is configured to interact with a user including conveying data to a user (e.g., displaying data for observation by the user, audibly communicating data to a user, etc.) as well as receiving inputs from the user (e.g., tactile input, voice instruction, etc.). Accordingly, in one exemplary embodiment, the user interface may include a display (e.g., cathode ray tube, LCD, etc.) configured to depict visual information and an audio system as well as a keyboard, mouse and/or other input device. Any other suitable apparatus for interacting with a user may also be utilized.

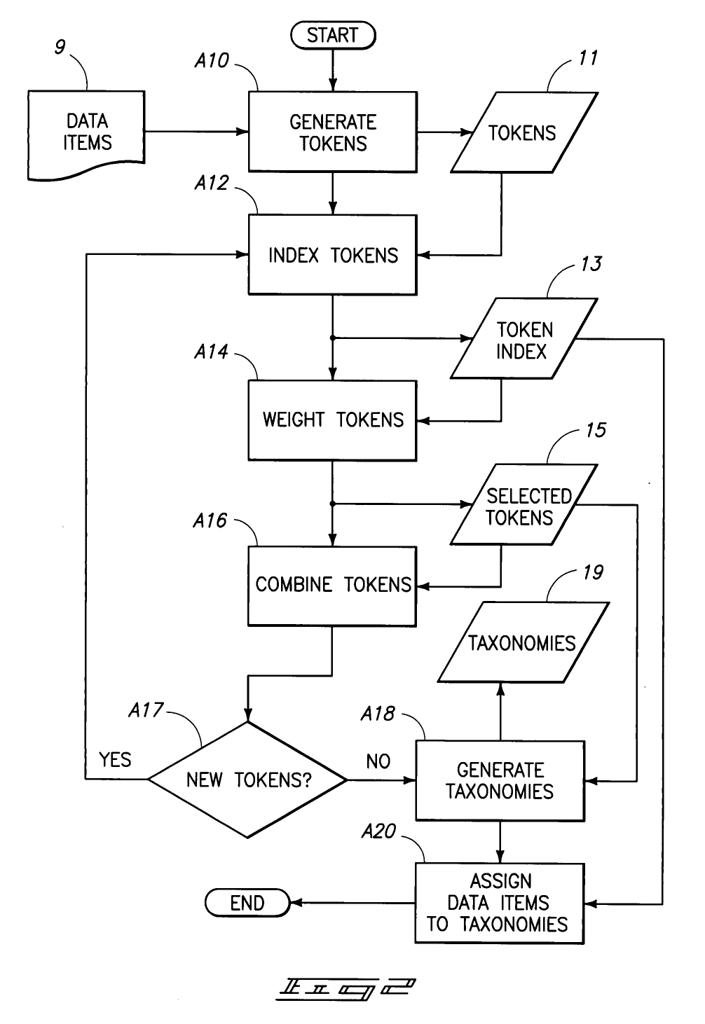

Example methods of the disclosure are described below with respect to FIGS. 2 and 5-7 which may be performed by processing circuitry 14 according to one embodiment. For example, processing circuitry 14 may execute executable code (e.g., machine instructions) to implement the disclosed methods in but one embodiment. Other methods are possible including more, less and/or alternative acts.

Referring to FIG. 2, one method is illustrated for generating taxonomies using a collection of data items 9 of a data set. In one more specific embodiment, the method of FIG. 2 automatically generates taxonomic information (e.g., taxonomies) from data which may include a plurality of unstructured heterogeneous data items (e.g., unstructured without pre-existing organization or classification and/or may include data items of different formats). Taxonomies are classification categories which may be used to classify data items 9 in one embodiment. Data items 9 may have different formats including, for example, text files, web pages, images (e.g., photograph files), paper documents, voice files, video files, molecules, and database query results in some examples. An example of a data set may be a collection of data items of a similar format or different formats in one embodiment.

At an Act A10, the processing circuitry operating as a tokenizer accesses the data items 9 and parses and tokenizes the data items to identify a plurality of tokens 11 which may be unique atomic units present in the data items 9 in one embodiment. In one embodiment, the tokens 11 have a common structure of content, such as words, alphanumeric characters, pixels, etc. of the data items 9. In some examples, the processing circuitry may access a data set of the data items 9 from communications interface 12 (e.g., from the Internet), storage circuitry 16 (e.g., in the form of a database), from user interface 18 (e.g., inputted by a user) and/or from another source. In one example for data items comprising text (e.g., documents), tokens 11 in the form of words may be generated. In another example for text, tokens 11 in the form of alphanumerical characters may be generated. In another example for data items in the form of images or photographs, tokens 11 in the form of pixels (e.g., with the corresponding RGB values) may be generated. Choice of the form of the tokens 11 may be domain and system dependent.

At an Act A12, the processing circuitry operates to index the tokens 11. In one embodiment, the processing circuitry 14 accesses the tokens 11 and places the tokens in respective memory addresses to create one example of an index 13 as shown in Table 1. Example memory addresses include RAM addresses, hard disk addresses, database surrogate keys, or any system addressable memory in illustrative examples.

TABLE 1

| Memory Address | Token |
|---|---|
| 0001 | Token 1 |
| 0002 | Token 2 |
| 0003 | Token 3 |

Once the tokens have been placed into index 13 in the form of Table 1, the processing circuitry operates in one embodiment to reconstruct individual data items as a collection of memory addresses for each token 11, for example, in another index 13 which may be in the form of a data item index shown in one example in Table 2.

TABLE 2

| Data Item | Token Set Memory Addresses |
|---|---|
| Data Item 1 | 0002, 0001, 0005, 0002, |
| Data Item 2 | 0006, 0006, 0008, 0010, |
| Data Item 3 | 0005, 0001, 0003, 0004, |

In one embodiment, the processing circuitry may create another index 13, for example, in the forma of an inverse or reverse index shown in Table 3 for individual data items 9 and to establish a reference to each data item 9 for each token 11.

TABLE 3

| Token | Data Item contained within |
|---|---|
| 0001 | Data Item 1, Data Item 3 |
| 0002 | Data Item 2 |
| 0003 | Data Item 3 |

Utilization of memory addresses for indexing of tokens 11 according to one embodiment may increase the performance of processing operations with respect to accessing tokens 11 (e.g., provide increased processing speed, compacting memory utilized for indexing operations, etc.). The above Tables 1-3 are examples and other alternative indexing schemes may be utilized. For example, a hash table without knowledge of memory addresses could be utilized.

At an Act A14, the processing circuitry may act as a weighter to assign weights or values to individual tokens 11. Further, processing circuitry 14 may select some of the tokens 11 high value tokens 15 (also referred to as selected tokens) which are considered to be highly indicative of data content of the data items 9 in one embodiment. In one embodiment, the processing circuitry uses a data item index 13 (such as shown in Table 2) to determine weighting values for the tokens 11 in the data set. In one example, a TFIDF algorithm may be utilized for the weighting and to determine the extents to which respective tokens 11 are indicative of content of the data items and/or data set. Details of the TFIDF algorithm are discussed at Salton, G. (1989), Automated Text Processing: The Transformation, Analysis, and Retrieval of Information by Computer, Addison-Wesley; http://en.wikipedia.org/wiki/Tf-idf; and Hand, D. J. (2001), Principles of Data Mining, MIT Press, the teachings of which are incorporated herein by reference. Higher weighted or valued tokens 11 are considered to be more indicative of the content compared with other tokens 11 having lower weights. Accordingly, in one embodiment, the tokens 11 may be ranked from highest to lowest with respect to extents of being indicative of content of the data items 9.

Using TFIDF according to one embodiment, the weight or value of a token is calculated as the token frequency of the token divided by the total number of tokens, times the log of the total number of data items divided by the number of data items in which the token appears, equations 1-3:
Token frequency (tf) for token i=nᵢ/(Σₖnₖ) (1)
Data item frequency (idf) of token i=log(|D|/{dᵢ:dD}, where D is the data item set and |D| is the total number of data items. (2)
TFIDF=tf*idf (3)

Using TFIDF in an example involving data items comprising textual content, a higher weighting value may be placed on important tokens while providing lower weighting values of unimportant high frequency tokens such as “the,” “and”, “if”, etc. For data items including images, a count frequency of an RGB value in a pixel space may be used. The above are examples and the choice of weighting values placed on individual tokens may be domain and system independent. Other weighting methods or techniques may be used in other embodiments.

The processing circuitry may operate to pass some of the tokens for generation of new tokens at an Act 16. In one embodiment, the processing circuitry 14 is configured to select and pass the high value tokens. In one embodiment, the processing circuitry may be configured to select the tokens which are indicated by the weighting to have the greatest or highest extents of being indicative of the content of the data items and/or data set compared with the other tokens. The number of tokens 15 which are selected and passed may be different in different configurations or applications. The ultimate number of tokens selected may be user and system dependent based on a value threshold for comparison to weights of all analyzed tokens (e.g., tokens having weights above the threshold are selected), a pre-defined desired number of high value tokens, or some combination thereof may be used in example embodiments. In one example, one may be interested in reading documents associated with circus elephants as opposed to wild elephants. Analysis of documents using the TFIDF algorithm may indicate “circus” and “elephant” as high value tokens which are selected for combination and the combined token “circus elephant” may be a third high value token used in subsequent analysis operations discussed herein (e.g., create taxonomies, chosen to determine data items associated with circus elephants, etc.)

At an Act A16, the method may formulate new tokens which are subsequently analyzed to determine if the newly generated tokens are high value tokens. In one embodiment, the method combines tokens with other data content of the data items 9 (e.g., combine selected tokens with other tokens) to formulate new tokens and which may be referred to as combined tokens. The combined tokens are not initially identified as tokens inasmuch as such include a plurality of tokens.

Different criteria may be utilized for determining which data content is to be combined with the selected tokens to form new tokens for further analysis. As described below, spatial relationships of the tokens and data content may be analyzed to determine if the tokens and data content are sufficiently near to one another for combination. In other embodiments, content of the tokens and data content may be analyzed to determine whether combination of the tokens and data content is appropriate. In one embodiment, distance information of tokens and data content may be used. In one example, high value tokens may be combined with other data content which is spatially near to the respective high value tokens in one possible implementation.

In one possible embodiment where the data items comprise text, new tokens may be formulated for each high value token by combining an individual high value token with the tokens which occur immediately before and after the high value token to form two new tokens. Accordingly, a plurality of new tokens may be formed for an individual high value token. In one embodiment, only tokens which occur within a single sentence of text of the data item are combined with one another. In one example, assume the following tokens occur in the text being analyzed: “the base on balls was,” and “base” and “balls” are identified as high value tokens. New tokens result from the combination including: “the base,” “base on,” “on balls,” and “balls was.” Accordingly, the high values tokens may be combined with data content other than other high value tokens in at least one embodiment.

In one possible embodiment where the data items comprise images, pixel information of pixels (e.g., RGB values) which are immediately adjacent to an individual high value token pixel (e.g., pixels which are immediately above, below and to the sides of the high value token pixel) is analyzed to determine whether combination is appropriate. In one example implementation, Hue-Lightness-Saturation (HLS) distance information is calculated for the high value token pixel with respect to each of the immediately adjacent neighboring pixels. Calculations of other criteria may be used in other embodiments (for example, comparing atomic sequences to analyze data items comprising molecules). The pixels are combined to form a new token if the distance information therebetween indicates that the pixel information is sufficiently close in distance. In one embodiment, where a threshold may be set for use in determining if pixels are sufficiently close in distance to be combined. For example, in one embodiment where an RGB color scheme is used (e.g., each RGB value for each pixel ranges from 0 to 255), the distance threshold could be set to 10 in one embodiment. Neighboring pixels with an RGB distance less than 10 are combined as a new token in one embodiment. Increasing the distance threshold would produce a more lax classification for images, while decreasing the distance threshold would require images to be more exact in likeness. Other embodiments are possible.

At an Act A17, it is determined whether any new tokens resulted from the combining at Act A16. If no, the process proceeds to an Act A18. If yes, the process returns to Act A12 to add the new tokens to the index and to Act A14 where the new tokens are weighted and the high value tokens (which may include some of the previously present high value tokens and some of the new tokens in one example) are passed for possible combination with other content at Act A16 to form additional new tokens. In one embodiment, the method is recursive and the Acts A12, A14, A16 are repeated until no new tokens result from Acts A12, A14, A16 as determined at Act A17.

At Act A18, the processing circuitry generates or identifies one or more taxonomies 19 responsive to the list of high value tokens 15 remaining constant as determined at Act A17. The tokens are ranked during the previous weighting to their extents of being indicative of data content of the data items and the high value tokens 15 having the highest weightings for having the greatest extents of being indicative of content of the respective data items may be selected as taxonomies 19. In one example of Act A18, the processing circuitry assigns high value tokens having the highest values as respective taxonomies. For example, a high value token such as “base on balls” may be one of the taxonomies in an example wherein the data items are text documents. In one embodiment, a number of taxonomies may be specified and the specified number of high value tokens having the highest weights may be selected as taxonomies. In another example, a threshold may be specified and all high value tokens having weights above the threshold may be selected as taxonomies. In another example, the highest value token of each of the data items may be selected as one of the taxonomies. Other embodiments are possible for determining the taxonomies 19.

At an Act A20, the processing circuitry may assign data items to the taxonomies. In one example, the processing circuitry utilizes the reverse index 13 to associate the data items with respective ones of the taxonomies 19. For example, a given data item may be assigned to the respective taxonomies 19 according to high value tokens or selected tokens 15 present in the respective data item. In one embodiment, the processing circuitry compares the high value tokens or selected tokens 15 to the taxonomies 19 and associates the data items 9 with respective ones of the taxonomies 19 using the high value tokens or selected tokens 15 present in the data items 9 and which have been selected as taxonomies 19. For example, if “baseball” is a high value token or selected token 15 present in a data item 9, and “baseball” has been selected as a taxonomy 19, then the respective data item 9 may be associated with or classified using the “baseball” taxonomy 19.

In one embodiment, for textual data items, the high value tokens of a data item may be individually compared with each of the taxonomies, and the data item may be associated or classified with each taxonomy which matched a high value token of the data item. Accordingly, a data item may be associated with a plurality of taxonomies in one embodiment. In one example, lemmas of the high value terms and taxonomies may be used for comparison. In an image example, HLS distance information may be used to compare high value tokens of a data item with the taxonomies and the data item may be associated with a taxonomy where the distance information of the comparison with the taxonomy is less than a threshold. If a data item is not associated with any of the taxonomies, the data item may be unclassified or one or more new taxonomy may be created using the high value terms of the data item. Other methods for associating are possible in different embodiments.

In one example, the data set of data items may be readily searched following the classification operations of FIG. 2. In addition, at least some acts of the method of FIG. 2 may be utilized in other methods for additional applications as described in below with respect to additional illustrative embodiments of the disclosure.

To serve as an example of analysis of data items in the form of text documents for the method of FIG. 2, a small set of documents were provided based on two unique taxonomies: the US civil war and baseball. The documents used in the example to represent the US civil war were Lincolns' speeches including the first and second inauguration speeches and the Gettysburg address. The documents used to represent baseball were the poems, “Casey at the Bat” by Ernest Thayer Lewis, “Baseball Is” by Greg Hall and “The Game I Love” by John McClusky.

Initially, the documents were parsed for the unique atomic tokens, and in this example, the unique atomic tokens were the words in each document. Table 4 shows the unique atomic tokens resulting from the parsing for the first sentence in. Lincoln's Gettysburg address and the first sentence in the poem “Baseball Is”.

TABLE 4

| Gettysburg Address | “Baseball Is” |
|---|---|
| A | And |
| Ago | Ball |
| All | Baseball |
| And | Chalk |
| Are | Differently |
| Brought | Dirt |
| Conceived | Displayed |
| Continent | Ever |
| Created | Every |
| Dedicated | Grass |
| Equal | Has |
| Fathers | Heard |
| Forth | In |
| Four | Is |
| In | Park |
| Liberty | Play |
| Men | Same |
| Nation | That |
| New | The |
| On | Words |
| Our | Yet |
| Proposition | |
| Score | |
| Seven | |
| That | |
| The | |
| This | |
| To | |
| Years | |

The method passes the tokens for indexing where each token is assigned to a unique memory address (e.g., provided the incoming tokens are unique from previous determined tokens). For example, both the Gettysburg address and “Baseball Is” contain the words “And”, “In” and “The” and only one memory address would be assigned to each token. Each of the documents is reconstructed as the memory addresses of the tokens, and a reverse index is created indicating for which documents each respective token belongs to.

The tokens are weighted after indexing. In the presently-described example, the tokens with the highest token frequency for the Gettysburg Address are “that”, “the”, “here”, “to”, “we”, but these tokens also figure prominently in the other documents including the baseball documents. Therefore, the TFIDF value becomes very low for these tokens due to the IDF of the tokens. The high value tokens for the Gettysburg address are “nation”, “dedicated” and “great”. In the first inaugural address of Lincoln, the high value tokens are “Constitution”, “government” and “States”. In his second inaugural address, the high value tokens are “war”, “God” and “Union”. The token “war” is mentioned in every speech of Lincoln but since the baseball documents do not reference “war”, the IDF of “war” is not zero.

Following weighting, selected or high value tokens are analyzed for possible combination. In this example, a distance calculation is used to determine near tokens, which is the proximity of the tokens in a sentence. From the Lincoln speeches, “civil” and “war” are high value tokens and the distance analysis shows they are next to each other. The tokens are combined to create a new token, “civil war”. The new tokens are indexed, weighted and combined. This process repeats continuously until the list of selected or high value tokens remains constant in one embodiment. Furthermore, once the list is constant, the taxonomies are derived from the selected or high value tokens. From the Lincoln speeches, the following taxonomies are derived: “union”, “people”, “constitution”, “government”, “states”, “nation”, “war” and “civil war”. From the baseball poems, the following taxonomies are derived: “baseball”, “Casey”, “ball”, “bat”, “game” and “cards”. In both cases, relevant context is extracted to derive the proper taxonomies. Furthermore, some combined tokens may provide additional information regarding the content of the data items over and above that which can be derived from other tokens taken individually. For example, “civil war” provides information regarding the content of the data items which is in addition to that which is derived from the tokens “civil” and “war” taken individually (i.e., the data items refer to a civil war, as opposed to any war).

Furthermore, the data items may be assigned to the taxonomies. In the described example, a high value token for Lincoln's first inaugural address, is “constitution” and a high value token for the second inaugural address is “war” and the method would assign those data items to the respective taxonomies “constitution” and “war”. Each document of the data set (e.g., corpus) may be assigned to one or more closely related taxonomy based on the document's high value token(s) as discussed above in one embodiment. In an alternative embodiment, only the highest value token of a data item is used for assigning the data item to one of the taxonomies.

In one embodiment, a one-to-many mapping may also be implemented to map a data item to multiple taxonomies, for example, based upon the high value tokens of the data item. Also, additional data items which occur may be individually assigned to an existing taxonomy that matches a high value token of the data items. In one embodiment, new taxonomies may be generated for high value tokens of data items which do not match an existing taxonomy.

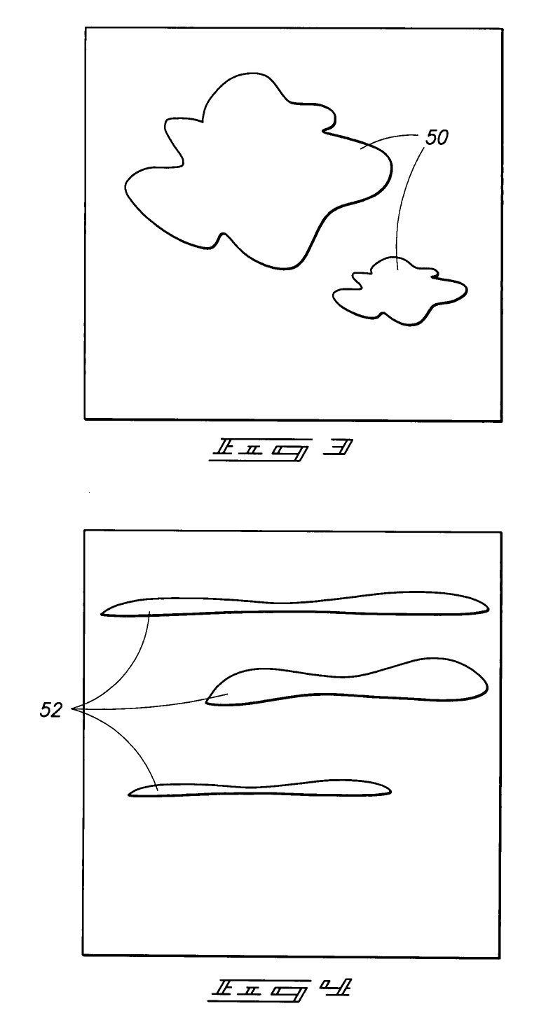

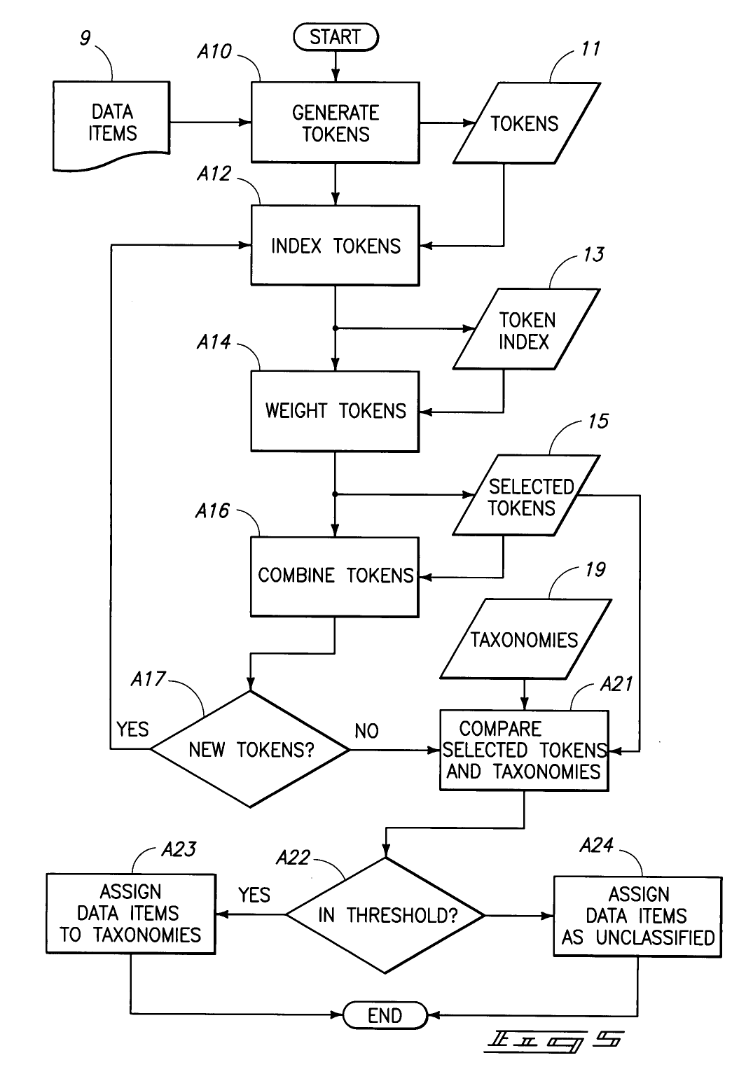

Another example is described below for generating taxonomies around data items comprising images, such as images drawn to represent cumulus clouds 50 (FIG. 3) and stratus clouds 52 (FIG. 4). The clouds are white and the backgrounds are blue in the described example. In this example, the images having RGB values for the pixels are parsed and tokenized into individual pixels. Memory addresses are assigned for each pixel and the data items are reconstructed as respective collections of the memory addresses.

Thereafter, the tokens are weighted where the frequency counts of occurrences for each RGB value are multiplied by the number of pixels for the token (i.e., in this example the number of pixels for each token is one). Distance calculations are made using the HLS distance between the RGB value for a token and the neighboring pixels of the token. If a neighboring pixel has a close distance to the pixel HLS value, then the respective pixels are combined to construct a new token which is a collection of the neighboring pixels. The new token of the collection of pixels is indexed to a memory address. Further, the new token is weighted. The high value tokens are analyzed for possible combination wherein, for individual high value tokens, the distance between the token and neighboring pixels is calculated to determine whether to construct a new combined token. The process continues until the list of high value tokens remains constant in the described example.

The taxonomies that are derived for the two images in this example are different for the cloud structures but the same for the background. For example, the cumulus cloud produces taxonomies which are substantially square collections of white pixels and square blocks of blue pixels and the stratus cloud produces taxonomies which are substantially rectangular collections (e.g., lines) of white pixels and square blocks of blue pixels. The cumulus cloud image of FIG. 3 is assigned to the taxonomy of square blocks of white pixels while the stratus cloud image of FIG. 4 is assigned to the taxonomy of the line collection of white pixels. The taxonomies can also be labeled with text, such as cumulus and stratus, respectively.

It is apparent that data processing apparatus 10 may execute the method of FIG. 2 to automatically define taxonomies and/or classify data items (e.g., associating data items with respective taxonomies) without user input or assistance in at least one embodiment. More specifically, in one embodiment, user review of the content of the data items is not needed to define taxonomies and/or classify the data items which may greatly reduce time for defining taxonomies and data item classification as well as the amount of labor on the part of a user.

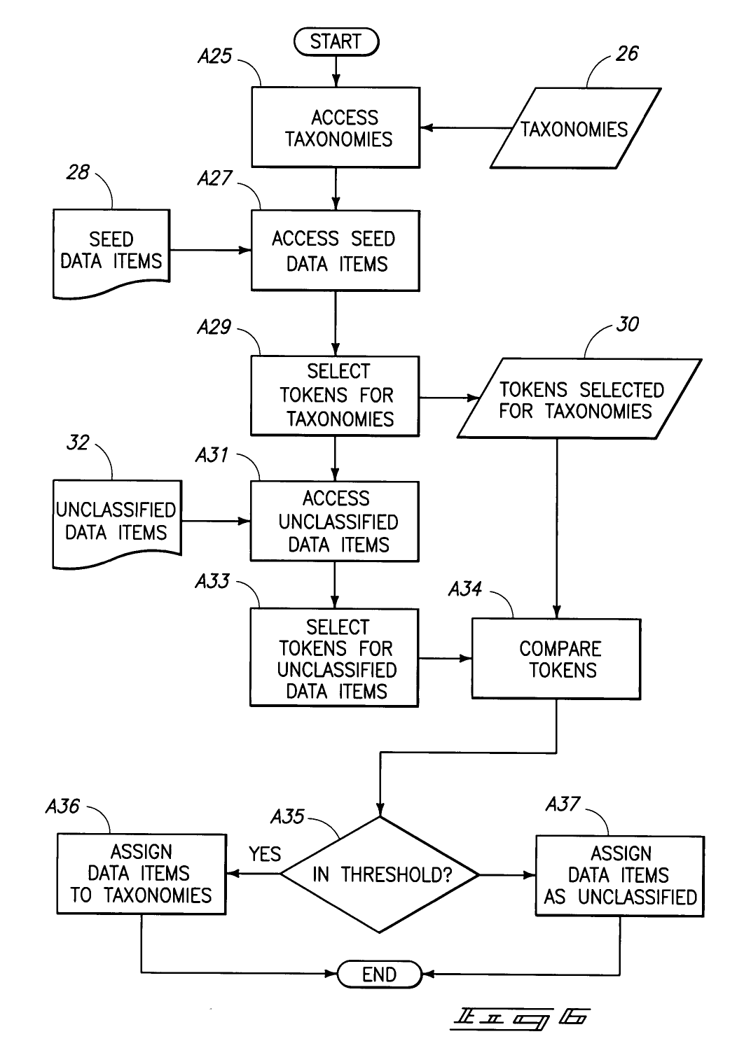

Referring to FIG. 5, a method is shown which may be used to classify a plurality of data items by associating the data items with a plurality of taxonomies (e.g., pre-existing taxonomies and perhaps also taxonomies newly formed from the processing of the data items). In one embodiment, at least some of the taxonomies 19 may be inputted by a user or otherwise defined before the processing of data items 9.

In FIG. 5, a set of existing taxonomies 19 may be provided for example by a user or other source and accessed by the processing circuitry. The taxonomies 19 may comprise a plurality of classification categories which are desired to be used to classify the data items 9.

A data set of data items 9 to be classified is accessed and the processing circuitry may perform some of the same acts described above at FIG. 2 with respect to the accessed data items 9. For example, Acts A12, A14, A16 may be recursively executed to identify selected or high value tokens 15 for the data items 9 in one embodiment.

At an Act A21, the selected or high value tokens 15 of the data items 9 are compared with the taxonomies 19 which may be in the form of tokens.

At an Act A22, the method attempts to associate or assign data items 9 to the respective closest taxonomies 19 in one embodiment. For example, it may be determined whether the comparison by Act A21 of the selected or high value tokens 15 provided comparison results within a threshold. In one example, the threshold may determine whether there is a direct match of a high value token 15 of a data item 9 with one of the taxonomies 19. However, the threshold may be parametric and other thresholds may be used to determine whether a high value token 15 of a data item 9 and a taxonomy 19 are sufficiently close in other embodiments.

The method proceeds to an Act A23 if the threshold is satisfied for a high value token of a data item 9. At Act A23, the respective data item 9 including the high value token 15 may be classified using the respective taxonomy 19 which was determined to be sufficiently close with the high value token 15 in one embodiment.

At Act A24, the method may indicate data items 9 as unclassified wherein the high value tokens 15 thereof failed to be sufficiently close to any of the taxonomies 19 in one embodiment. In another embodiment, the high value tokens 15 of the data items 9 which did not meet the threshold criteria of Act A22 may be used to generate new taxonomies 19 and the respective data items 9 may be classified using respective ones of the new taxonomies 19.

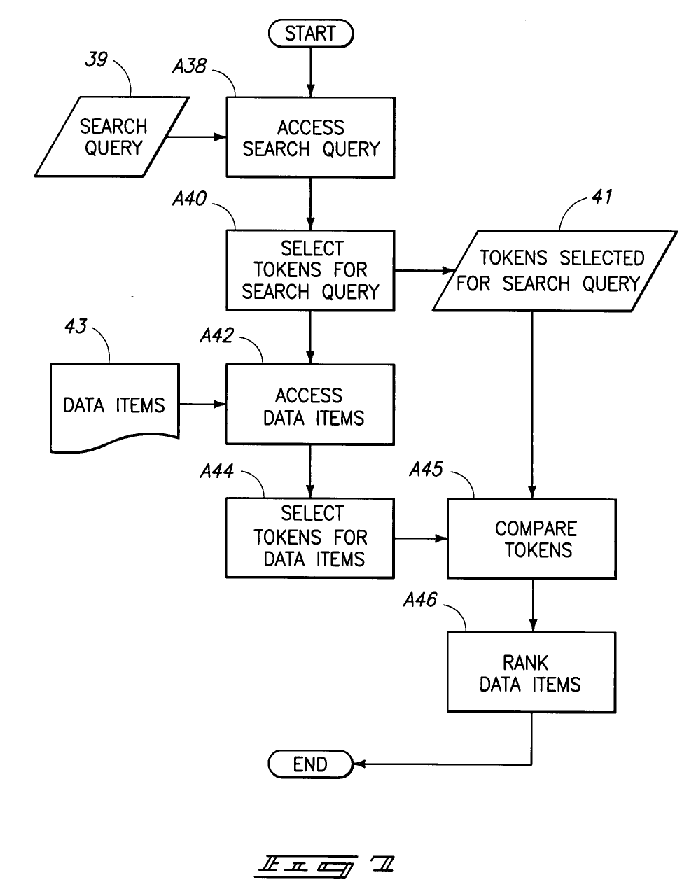

Referring to FIG. 6, another method is shown for classifying data items using a plurality of taxonomies 26. In one embodiment, one or more taxonomies 26 may be predefined (e.g., defined before processing of unclassified data items for example by a user) and used to classify data items 32 during the classification. In the described embodiment, the user may also provide another data set of data items in the form of a plurality of seed data items 28 corresponding to the taxonomies 26 and which may be pre-processed to seed the taxonomies 26 as described further below. The seed data items 28 may be provided as examples and/or otherwise representative of the respective taxonomies 26. Thereafter, the classification operations are substantially automatic wherein the data processing apparatus 10 may classify unclassified data items 32 of a data set without additional user operation in one embodiment.

At an Act A25, the processing circuitry may access one or more predefined taxonomies 26 which are to be used to classify the data items to be classified.

At an Act A27, the processing circuitry may access one or more seed data items 28 for each of the taxonomies. For example, a user may input or otherwise provide the seed data items 28 for respective ones of the taxonomies 26 and which may guide the future classification operations performed by the data processing apparatus 10 to locate data items which are similar to the seed data items 28 for the respective taxonomies 26.

At an Act A29, the processing circuitry may process the seed data items 28 (e.g., recursively using steps A12, A14, A16 of FIG. 2) to determine high value tokens for respective ones of the taxonomies 26.

At an Act A31, the processing circuitry may access data items 32 of a data set to be processed and classified and which may be initially unclassified.

At an Act A33, the processing circuitry may process the accessed data items 32 (e.g., recursively using steps A12, A14, A16 of FIG. 2) to determine high value tokens for respective ones of the data items 32.

At an Act A34, the high value tokens of the data items 32 are compared with the high value tokens 30 of the taxonomies 26.

At an Act A35, the method attempts to assign data items 32 to the closest taxonomy 26 in one embodiment. For example, it may be determined whether the comparison by Act A35 of the high value tokens provided comparison results within a threshold. In one example, the threshold may determine whether there is a direct match of a high value token of a data item 32 with any of the high value tokens 30 of the taxonomies 26. However, the threshold may be parametric and other thresholds may be used to determine whether high value tokens of data items 32 and taxonomies 26 are sufficiently close in other embodiments.

The method proceeds to an Act A36 if the threshold is satisfied for a respective data item 32. At Act A36, the respective data item 32 may be classified using a respective taxonomy 26 when a high value token 30 of the taxonomy 26 was determined to be sufficiently close with a high value token of the data item 32 in one embodiment.

At Act A37, the method may indicate as unclassified the data items 32 wherein the high value tokens thereof failed to be sufficiently close to the high value tokens of the taxonomies 26 in one embodiment. In another embodiment, the high value tokens of the data items 32 which did not meet the threshold criteria of Act A35 may be used to generate new taxonomies 26 and the respective data items 32 may be classified using respective ones of the new taxonomies 26 in one example.

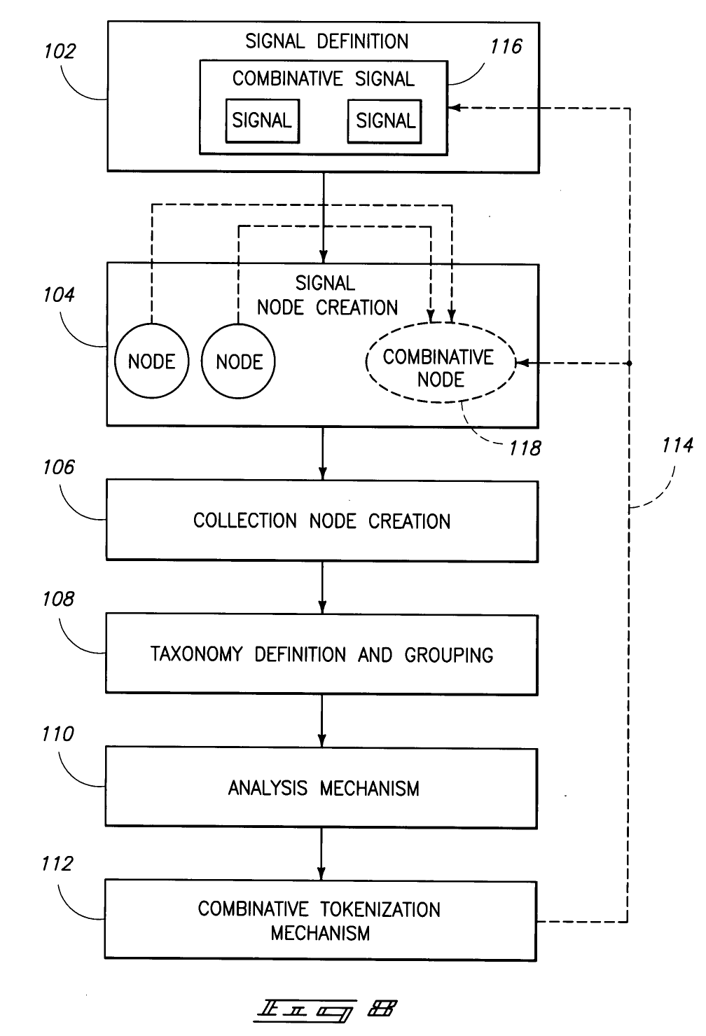

Referring to FIG. 7, a search engine which may be implemented by data processing apparatus 10 to search a data set of data items is described according to one embodiment.

At an Act A38, the processing circuitry accesses a search query 39 which may be inputted by a user or otherwise provided. The search query may be used to guide or steer the analysis of the data set to return a desired set of data items relevant to the search query 39. One example of search query 39 for text may be one or more words. In another example, a user may provide the search query 39 in the form of an input data item (e.g., text document, image, etc.) which is used by the data processing apparatus to locate similar data items. Other search queries are possible.

At an Act A40, the processing circuitry processes the search query 39 to identify high value tokens 41. If the search query 39 is one or more words (e.g., baseball game), each of the words of the search query 39 may be selected as high value tokens 41 and which may be referred to as search tokens. In another example where search query 39 is an inputted data item, such as a document or image, the processing circuitry may recursively perform the steps A12, A14, A16 to identify selected or high value tokens 41 for the search query 39.

At an Act A42, the processing circuitry accesses the data items 43 of the data set to be searched. The data items 43 to be searched may be provided in any suitable manner. In one example embodiment using textual data items, a document crawler (e.g., web crawler, network crawler, email sniffer or other possible software agents configured to search and parse document repositories) captures the documents to be searched.

At an Act A44, the processing circuitry identifies high value tokens for the data items 43. In one embodiment, the processing circuitry may performing processing similar to FIG. 2 where Acts A12, A14, A16 may be recursively executed to identify high value tokens for the data items 43 in one embodiment. In another example, the data items 43 may have been pre-processed and the high value tokens may already be known.

At an Act A45, the processing circuitry compares the high value tokens of the data items 43 with the search tokens of the search query 39. In one embodiment, the comparison includes matching the search tokens of the data items 43 and the search tokens of the search query 39. In one embodiment, each search token may be compared to each high value token of a data item and the results of each of the comparisons for the data item may be added to give a cumulative score for the data item and which may be used to rank the data items. In another example, a subset of the high value tokens may be used for a given data item. Examples of comparison include matching lemmas for textual data items or using HLS distance calculations for images. The methods herein for determining closeness or similarity are examples and other criteria may be used in other embodiments, including for example, analyzing additional types of data items other than text or images.

At an Act A46, the data items 43 may be ranked by closeness of the high value tokens of the data items 43 with the high value tokens 41 of the search query 39 (e.g., to rank the data items 43 by relevancy to the search query 39). In one embodiment, a cumulative score of the compared tokens may be used as described above. Thereafter, a user may select the highly ranked data items 43 having the closest high value tokens and which may be more relevant to the search query 39 compared with lower ranked data items. In other embodiments, the data items may be ranked by dissimilarity to the search tokens.

At least some embodiments of the disclosure are directed to method and apparatus for organizing, classifying, searching and processing a plurality of data items. In one embodiment, taxonomies may be automatically generated for unstructured data in groups of data items wherein user effort to assign data items to taxonomies is reduced, minimized or estimated compared with some other systems.

Some embodiments of the methods and data processing apparatus 10 provide additional advantages compared with other arrangements. For example, to circumvent problems associated with processing unstructured data, some computer information retrieval systems (search engines) use a variation of a text index structure, such as an inverted index. This allows for a retrieval of files containing a particular set of tokens that while more efficient than a linear search, still suffers several disadvantages. For example, these indices may assume that each record or file is identified by a unique ID assigned through hashing or enumeration. Applying this ID, the index consists of numerous inverted lists, where each inverted list contains the IDs of all the documents in a collection that contain a given term, sorted by document ID or some similar measure. Some approaches lack any “valuing method” and a means of ranking the information returned by such systems may be to simply compare the query to the related files (based again on tokens) as an unstructured or semi-structured collection of tokens. The text files may be modeled as unordered bags of words, and a ranking function may assign a score to each document with respect to the current query, based on the frequency of each query term in the file, and in the overall collection of files.

However, these systems imply further limitations and disadvantages. For example, for large indices, there are few viable strategies for partitioning. The indexing can significantly increase storage and processing requirements. Furthermore, simple, linear queries can involve traversing widely separated portions of the index. In addition, adding documents to the database may involve computationally and temporally expensive re-indexing of multiple elements. Programmers who do not understand the internal (and widely varying scoring methods) may innocently poison the return scores for scaled indexes. With the existence of these issues, and even though such a linear search is typically much slower, experts in the field may rely on faster processing speeds to perform linear searches using such tools as “agrep” for datasets measured in the megabytes.

In typical incarnations of text retrieval, search queries are broken into keywords that are used to match the keywords of a document set. These methods return any document containing those keywords. However, indexing tokens as described herein provides as a direct route from the high value tokens to the data items in a corpus. The more matches a query has to the high value tokens of a data item, the higher the value the data item has to the query. For a text query, each word and combination of words of the query would retrieve the high value documents directly from the indexed tokens. This is a faster mechanism than searching each document in a corpus for the frequency of the search keywords in a document. Where an image is used as the query, the shortest HLS distance of the high value image query tokens to the indexed high value image tokens would find the images in the data set most like the image query due to the distance calculation. Exact matches would have a HLS distance of zero.

In one embodiment, a device comprising computer software and/or hardware is used to capture and write data, signals, or tokens into blocks of computer memory in such a manner that each such block is singularly representative of every occurrence of a distinct piece of granular data, signal, or token. Further, these blocks are referenced in a manner in one example such that they may be acted on as nodes that may be referenced individually or collectively. Further, relationships between and amongst nodes can yield differential data and enable reconstruction. Moreover, the device is recursive in one embodiment, allowing collective signals or tokens or discoveries within the differential data to be tokenized and indexed within the same system. Example embodiments of the disclosure provide one or more of the following distinct advantages including, being dynamic, so new signals may be added to the system without rebuilding the index, classification of data without querying a lookup table for location of the data and which is faster than some arrangements wherein a lookup table is queried.

In one embodiment, signals are linked by reference rather than indexed by position within a document which permits more straightforward reconstruction of data-grams, faster count of references in a one or more data-grams, and building of combined signals during a query without re-indexing the documents (dynamic signal creation). In addition, signals are constant once recognized as complete signals which permits extraction of the same words from the data-gram without pattern matching. Further, storage needs of some embodiments of the systems of the disclosure do not grow in a linear manner. In addition, variable formulas can be applied to a classification system in one embodiment without changing what data is referenced.

Referring to FIG. 8, another embodiment of the disclosure is described. This described embodiment may be implemented as a computer program or an element of a program which provides a heterogeneous mapped address indexing system with dynamic signal definition which allows computer systems to quickly retrieve and examine signals and collections of signals and determine their likely relationships, with or without taxonomic information. The overall mechanism is comprised, in general, of six distinct sub-mechanisms in one embodiment.

A signal definition mechanism 102 defines either statically, or by attribute, what comprises a granular clean signal in one embodiment. It accepts data and tokenizes it into acceptable signals. It then submits this data to a signal node creation mechanism 104 that compiles a list of all the unique signals encountered in a given collection (e.g., document or file) and assigns each of them to a location in memory in the described embodiment. The data now passes to a collection node creation mechanism 106 that compiles a list of every collection read by the signal node creation mechanism 104 to create the list of unique signals in the described embodiment.

In one implementation, each collection (e.g., document or file) may be recorded in memory as a list of addresses that represent the signals as they occurred, contiguously, in a particular collection. Uniquely defined signals, documents and groups are given an address in physical memory (RAM) that each super-signal or meta-token, document or group can refer to as a signal that it uses in one embodiment. These locations may be statically defined and thus a map or look-up table for each location can be created. This allows for a fast reference count of each signal in all other signals, documents, or groups and fast traversal of the index in one embodiment.

In one embodiment, the data may now also pass to a taxonomy definition and grouping mechanism 108 which determines taxonomic information related to the collections it has committed to memory via the collection node creation mechanism 106. This mechanism 108 may use a taxonomy definition provided by an outside system or user to combine the recorded collections into meta-collections—groups and sub-groups of related information within the collections in one embodiment.

At any point after the data has been processed into collections, the analysis mechanism 110 may apply any number of algorithms or methods to measure and quantify relationships of granular data to other granular data, granular data to collections, collections to collections, collections to groups, and groups to groups in illustrative examples. In one embodiment, this analysis can then be applied by the combinative tokenization mechanism 112 and the deterministic information provided by the analysis mechanism 110, with or without other information provided to the mechanism by an outside user or system (i.e., rules), can be used to create, measure, or tokenize new symbols 114 and submit these back to either the signal definition mechanism 102 to define a combinative signal 116 and/or the signal node creation mechanism 104 to define a combinative node 118, as appropriate.

In addition to usefulness as a heterogeneous mapped address indexing system with dynamic signal definition, aspects of the disclosure can be used to optimize retrieval of indexes and collections across grid computing mechanisms, create taxonomic archetypes for neural computing, process and react to diverse signals in language independent environments, cache signals or collections for immediate retrieval by computer appliances, and/or operate as an inference engine or fuzzy rule based system.

At least some aspects of the disclosure provide methods and systems which may be simpler in construction, more universally usable, and more versatile in operation compared with other arrangements. Data may be added without re-indexing of information is since indexing is dynamic in one embodiment. In one embodiment, data may be rapidly searched with relatively high accuracy. Generated data and deterministic signals may be arranged to facilitate use by other computing devices in one embodiment. In one arrangement, methods and systems of the disclosure may be used as a mechanism of an inference engine and/or to create knowledge bases that can be dynamically swapped within a system or program and may have functionality with respect to an increased number of existing devices in the marketplace. Methods and systems of the disclosure may be used to scale the indexing and retrieval of large amounts of data and/or to observe and classify data without writing an index to the file system in example embodiments.

Aspects herein have been presented for guidance in construction and/or operation of illustrative embodiments of the disclosure. Applicant(s) hereof consider these described illustrative embodiments to also include, disclose and describe further inventive aspects in addition to those explicitly disclosed. For example, the additional inventive aspects may include less, more and/or alternative features than those described in the illustrative embodiments. In more specific examples, Applicants consider the disclosure to include, disclose and describe methods which include less, more and/or alternative steps than those methods explicitly disclosed as well as apparatus which includes less, more and/or alternative structure than the explicitly disclosed structure.

In compliance with the statute, the disclosure has been described in language more or less specific as to structural and methodical features. It is to be understood, however, that the disclosure is not limited to the specific features shown and described, since the means herein disclosed comprise preferred forms of putting the disclosure into effect. The disclosure is, therefore, claimed in any of its forms or modifications within the proper scope of the appended claims appropriately interpreted in accordance with the doctrine of equivalents.

1. A data processing method comprising:
identifying a plurality of tokens for a plurality of data items;
first selecting some of the tokens of the data items as being indicative of content of respective ones of the data items;
after the first selecting, combining the first selected tokens with other content of the data items to form combined tokens; and
after the combining, second selecting some of the tokens including at least one of the combined tokens as being indicative of content of the data items.

2. The method of claim 1 further comprising ranking the tokens as to extents of the tokens being indicative of content of the data items, and wherein the first and second selecting individually comprise selecting the tokens having the greatest extents of being indicative of content of the respective data items compared with non-selected tokens.

3. The method of claim 1 wherein the combining comprises combining the first selected tokens with the other content which comprises content of the data items other than the first selected tokens.

4. The method of claim 1 further comprising repeating the first selecting and the combining before the second selecting.

5. The method of claim 1 further comprising:
repeating the first selecting and the combining to provide additional first selected tokens; and
determining a moment in time during the repeating that no new combined tokens result from the combining during the repeating, and wherein the second selecting comprises selecting responsive to the determining.

6. The method of claim 1 further comprising identifying a plurality of taxonomies using the second selected tokens.

7. The method of claim 6 further comprising associating at least some of the data items with respective ones of the taxonomies.

8. The method of claim 7 wherein the at least some of the data items are assigned to respective ones of the taxonomies according to the second selected tokens present in respective ones of the data items.

9. The method of claim 6 wherein the taxonomies are classification categories which are indicative of the content of the data items.

10. The method of claim 6 further comprising ranking the second selected tokens as to extents of the second selected tokens being indicative of the content of the data items, and wherein the identifying the taxonomies comprises selecting some of the second selected tokens as the taxonomies responsive to the second selected tokens having the greatest extents of being indicative of the content of the respective data items.

11. The method of claim 6 wherein the identifying comprises identifying, for each of the data items, the second selected token having a greatest extent of being indicative of data content of the respective data item, and selecting the identified second selected tokens as the taxonomies.

12. The method of claim 6 further comprising:
comparing the taxonomies with the second selected tokens; and
associating at least some of the data items with respective ones of the taxonomies using the comparing.

13. The method of claim 1 further comprising:
providing a plurality of taxonomies;
comparing the taxonomies with the second selected tokens; and
assigning at least some of the data items to respective ones of the taxonomies using the comparing.

14. The method of claim 13 wherein the data items comprise first data items of a first data set and the second selected tokens comprise initial second selected tokens, and further comprising:
providing a second data set comprising a plurality of second data items; and
performing the identifying, the first selecting, the combining and the second selecting using the second data items and which provides a plurality of additional second selected tokens, and wherein the comparing comprises comparing the additional second selected tokens and the taxonomies.

15. The method of claim 1 further comprising:
providing a search query;
comparing the search query with the second selected tokens; and
ranking the data items using the comparing.

16. The method of claim 15 wherein the comparing comprises comparing tokens of the search query with the second selected tokens.

17. The method of claim 15 further comprising performing the identifying, the first selecting, the combining and the second selecting using the search query to provide at least one selected search token, and wherein the comparing comprises comparing the selected search token and the second selected tokens.

18. The method of claim 1 wherein the combining comprises combining the first selected tokens with the other content which comprises others of the tokens.

19. The method of claim 18 wherein the combining comprises combining using relationships of spatial locations of the first selected tokens with respect to the others of the tokens.

20. The method of claim 18 further comprising analyzing relationships of content of the first selected tokens with respect to the others of the tokens, and wherein the combining comprises combining responsive to the analyzing.

21. The method of claim 1 wherein the identifying the tokens identifies initially identified tokens and the combined tokens are not present in the initially identified tokens.

22. The method of claim 1 wherein the identifying, the first selecting, the combining and the second selecting comprise identifying, first selecting, combining and second selecting using processing circuitry.

23. The method of claim 1 wherein the identifying comprises identifying the tokens individually having a common structure of content of the data items, and wherein the combined tokens individually include a plurality of the common structures of the content of the data items.

24. A data processing method comprising:
first determining extents to which a plurality of tokens of a plurality of data items are indicative of content of the data items;
first selecting a plurality of first tokens using the first determining;
combining the first tokens with other content of the data items to form a plurality of second tokens;
second determining extents to which the second tokens are indicative of content of the data items; and
second selecting at least one of the second tokens using the second determining.

25. The method of claim 24 wherein the first and second selecting individually comprise selecting the first tokens and the at least one of the second tokens which have the greatest extents of being indicative of data content of the data items compared with non-selected tokens.

26. The method of claim 24 wherein the combining comprises initial combining, and further comprising:
repeating a subsequent combining to form additional ones of the second tokens; and
determining that no new second tokens result during the repeating, and wherein the second selecting is responsive to the determining.

27. The method of claim 24 further comprising using at least some of the second selected tokens as taxonomies.

28. The method of claim 24 further comprising using the second selected tokens to classify the data items.

29. The method of claim 24 further comprising comparing the second selected tokens with a search query to search the data items.

30. A data processing apparatus comprising:
processing circuitry configured to access a plurality of data items, to first determine extents to which a plurality of tokens of the data items are indicative of content of the data items, to first select a plurality of first tokens using the first determination, to combine the first selected tokens with other content of the data items to form a plurality of combined tokens, to second determine extents to which the combined tokens are indicative of content of the data items, and to second select at least some of the combined tokens using the second determination.

31. The apparatus of claim 30 wherein the processing circuitry is configured to select the first tokens and the at least some of the combined tokens responsive to the selected first tokens and the selected at least some of the combined tokens having the greatest extents of being indicative of content of the respective data items compared with non-selected tokens.

32. The apparatus of claim 30 wherein the processing circuitry is configured to repeat the first selecting and the combining before the second determining and the second selecting.

33. The apparatus of claim 32 wherein the processing circuitry is configured to cease the first selecting and the combining responsive to no new combined tokens being formed by the combining.

34. The apparatus of claim 30 wherein the processing circuitry is configured to identify a plurality of taxonomies comprising classification categories using the second selected tokens.

35. The apparatus of claim 30 wherein the processing circuitry is configured to associate at least some of the data items with respective ones of a plurality of taxonomies.

36. The apparatus of claim 35 wherein the processing circuitry is configured to compare the taxonomies with the second selected tokens and to associate the at least some the data items with respective ones of the taxonomies using the comparison.

37. The apparatus of claim 30 wherein the processing circuitry is configured to access a search query, to compare the second selected tokens with the search query, and to rank the data items according to relevancy to the search query using the comparison.

38. The apparatus of claim 30 wherein the processing circuitry is configured to combine the first selected tokens with the other content of the data items which comprises others of the tokens.

39. The apparatus of claim 38 wherein the processing circuitry is configured to combine the first selected tokens with the others of the tokens using distance information of the first selected tokens with respect to the others of the tokens.

40. The apparatus of claim 39 wherein the processing circuitry is configured to combine the first selected tokens with respective ones of the others of the tokens which are immediately adjacent to the respective ones of the first selected tokens.

41. The apparatus of claim 38 wherein the processing circuitry is configured to combine the first selected tokens with the others of the tokens responsive to analysis of content of the first selected tokens and the others of the tokens.

42. An article of manufacture comprising:
processor-usable media comprising programming configured to cause processing circuitry to perform processing comprising:
identifying a plurality of tokens for a plurality of data items;
first selecting some of the tokens of the data items as being indicative of content of respective ones of the data items;
after the first selecting, combining the first selected tokens with other content of the data items to form combined tokens; and
after the combining, second selecting some of the tokens including at least one of the combined tokens as being indicative of content of the data items.

43. The article of claim 42 wherein the first and second selecting individually comprise selecting the first selected tokens and the second selected tokens which have the greatest extents of being indicative of the data content of the data items compared with non-selected tokens.

44. The article of claim 42 wherein the programming is configured to cause the processing circuitry to perform processing comprising repeating the first selecting and the combining to form additional ones of the combined tokens before the second selecting.

45. The article of claim 42 wherein the programming is configured to cause the processing circuitry to perform processing comprising selecting at least some of the second selected tokens as taxonomies.

46. The article of claim 42 wherein the programming is configured to cause the processing circuitry to perform processing comprising using at least some of the second selected tokens to classify the data items.

47. The article of claim 42 wherein the programming is configured to cause the processing circuitry to perform processing comprising comparing the second selected tokens with a search query to search the data items.
